(19) United States
(12) Patent Application Publication
(10) Pub. No.: US 2018/0027593 A1
(43) Pub. Date: Jan. 25, 2018

(54) METHOD AND APPARATUS FOR RANDOM ACCESS IN WIRELESS COMMUNICATION

(71) Applicant: ELECTRONICS AND TELECOMMUNICATIONS RESEARCH INSTITUTE, Daejeon (KR)

(72) Inventor: Changhee LEE, Seoul (KR)

(73) Assignee: ELECTRONICS AND TELECOMMUNICATIONS RESEARCH INSTIT UTE, Daejeon (KR)

(21) Appl. No.: 15/654,679

(22) Filed: Jul. 19, 2017

(30) Foreign Application Priority Data
Jul. 20, 2016 (KR) 10-2016-0092212

(51) Int. Cl. H04W 74/08; H04L 5/00; H04W 74/00

(52) U.S. Cl. CPC H04W 74/0833; H04W 74/008; H04L 5/003; H04W 72/046

(57) ABSTRACT

A method, a terminal, and a base station for performing random access by receiving additional random access information from the base station after connecting to the base station, selecting a random access preamble based on the additional random access information, and performing the random access by using the selected random access preamble is provided.

### CROSS-REFERENCE TO RELATED APPLICATION

This application claims priority to and the benefit of Korean Patent Application No. 10-2016-0092212 filed in the Korean Intellectual Property Office on Jul. 20, 2016, the entire contents of which are incorporated herein by reference.

### BACKGROUND OF THE INVENTION

### (a) Field of the Invention

This relates to a method and apparatus for performing random access for enhancing the probability of success thereof by adjusting random access opportunities in a wireless communication system.

### (b) Description of the Related Art

In a cellular mobile communication system, a terminal uses a random access (RA) procedure to access a base station (or network). For example, in a Long Term Evolution (LTE) system, user equipment (UE) performs the RA to obtain uplink synchronization or to be allocated a cell-radio network temporary identifier (C-RNTI) which is unique to the UE.

However, if a plurality of terminals performs the random access at the same time, a success probability of the random access of the terminal decreases due to a collision that may occur in the random access procedure, and thus the terminal cannot access the base station (or network).

The above information disclosed in this Background section is only for enhancement of understanding of the background of the invention and therefore it may contain information that does not form the prior art that is already known in this country to a person of ordinary skill in the art.

### SUMMARY OF THE INVENTION

An exemplary embodiment provides a method for performing random access based on additional random access information received from a base station.

Another exemplary embodiment provides a terminal performing random access based on additional random access information received from a base station.

Yet another exemplary embodiment provides a base station providing additional random access information to a terminal.

According to an exemplary embodiment, a method for performing random access by a terminal is provided. The method includes: receiving additional random access information from a base station after connecting to the base station; selecting a random access preamble based on the additional random access information; and performing the random access by using the selected random access preamble.

The additional random access information may include an index indicating a specific random access resource or an index indicating a specific random access resource group.

The receiving additional random access information may include receiving a paging message from the base station, and the method may further include, if the paging message includes the additional random access information, selecting the random access preamble based on the additional random access information, while if the paging message does not include the additional random access information, performing the random access according to the existing random access procedure.

The receiving additional random access information may include receiving a radio resource control (RRC) connection reconfiguration message from the base station, wherein the RRC connection reconfiguration message may include the additional random access information.

The receiving additional random access information may include receiving a radio resource control (RRC) connection release message from the base station, wherein the RRC connection release message may include the additional random access information.

The method may further include executing an additional random access timer for indicating a valid time duration of the additional random access information, and the selecting a random access preamble based on the additional random access information may include selecting the random access preamble based on the additional random access information when the connecting to the base station is completed before the additional random access timer expires.

The method may further include deleting the additional random access information after the additional random access timer expires.

According to another exemplary embodiment, a terminal performing random access is provided. The terminal may include a processor, a memory, and a radio frequency (RF) unit, wherein the processor executes a program stored in the memory to: receive additional random access information from a base station after connecting to the base station; select a random access preamble based on the additional random access information; and perform the random access by using the selected random access preamble.

The additional random access information may include an index indicating a specific random access resource or an index indicating a specific random access resource group.

When receiving additional random access information, the processor may receive a paging message from the base station, and the processor executes the program to further receive a paging message if the paging message includes the additional random access information, and select the random access preamble based on the additional random access information, and if the paging message does not include the additional random access information, the random access is performed according to the existing random access procedure.

When receiving additional random access information, the processor may receive a radio resource control (RRC) connection reconfiguration message from the base station, wherein the RRC connection reconfiguration message may include the additional random access information.

When receiving additional random access information, the processor may receive a radio resource control (RRC) connection release message from the base station, wherein the RRC connection release message may include the additional random access information.

The processor may execute the program to further execute an additional random access timer for indicating a valid time duration of the additional random access information, and when selecting a random access preamble based on the additional random access information, the processor may select the random access preamble based on the additional random access information when the connecting to the base station is completed before the additional random access timer expires.

The processor may further execute the program to delete the additional random access information after the additional random access timer expires.

According to yet another exemplary embodiment, a base station is provided. The base station includes a processor, a memory, and a radio frequency (RF) unit, wherein the processor executes a program stored in the memory to: transmit additional random access information to a terminal after the terminal is connected to the base station; receive a random access preamble selected based on the additional random access information; and transmit uplink resource allocation information to the terminal.

The additional random access information may include an index indicating a specific random access resource or an index indicating a specific random access resource group.

When transmitting additional random access information, the processor may transmit a radio resource control (RRC) connection reconfiguration message including the additional random access information to the terminal.

When transmitting additional random access information, the processor may perform transmit a radio resource control (RRC) connection release message including the additional random access information to the terminal.

The processor may further execute the program to delete the additional random access information after an additional random access timer for indicating a valid time duration of the additional random access information expires.

By performing random access based on the additional random access information received from the base station after connecting to the base station, the probability of collision between signals that may occur in random access can be reduced.

### BRIEF DESCRIPTION OF THE DRAWINGS

FIG. 1 is a flowchart illustrating a method for random access.

FIG. 2 is a flowchart illustrating a method for selecting a random access procedure by a terminal according to an exemplary embodiment.

FIG. 3 is a flowchart illustrating a method for performing random access by using an RRC connection reconfiguration message according to an exemplary embodiment.

FIG. 4 is a flowchart illustrating a method for performing random access by using an RRC connection release message according to an exemplary embodiment.

FIG. 5 is a block diagram illustrating a wireless communication system according to an exemplary embodiment of the present invention.

### DETAILED DESCRIPTION OF THE EMBODIMENTS

Hereinafter, exemplary embodiments of the present invention will be described in detail with reference to the accompanying drawings so that those skilled in the art may easily practice the present invention. However, the present invention may be modified in various different ways and is not limited to embodiments described herein. In the accompanying drawings, portions unrelated to the description will be omitted in order to obviously describe the present invention, and similar reference numerals will be used to describe similar portions throughout the present specification. Throughout the specification, a terminal may be called a mobile station (MS), a mobile terminal (MT), an advanced mobile station (AMS), a high reliability mobile station (HR-MS), a subscriber station (SS), a portable subscriber station (PSS), an access terminal (AT), user equipment (UE), a machine-type communication device (MTC device), and the like, and may include all or some of the functions of the MS, the MT, the AMS, the HR-MS, the SS, the PSS, the AT, the UE, the MTC device, and the like. Further, the base station (BS) may be called an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) serving as a base station, a relay node (RN) serving as a base station, an advanced relay station (RS) serving as a base station, a high reliability relay station (HR-RS) serving as a base station, small base stations (a femto base station (femto BS), a home node B (HNB), a home eNodeB (HeNB), a pico base station (pico BS), a macro base station (macro BS), a micro base station (micro BS), and the like), and the like, and may include all or some of the functions of the ABS, the node B, the eNodeB, the AP, the RAS, the BTS, the MMR-BS, the RS, the RN, the ARS, the HR-RS, the small base stations, and the like.

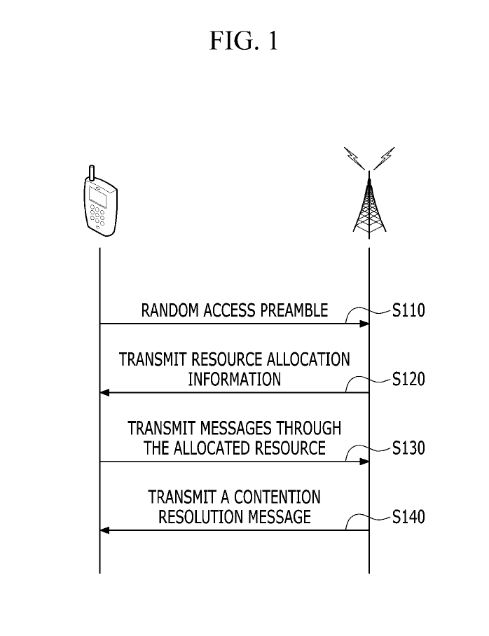

FIG. 1 is a flowchart illustrating a method for random access.

Referring to FIG. 1, a terminal transmits a preamble for the random access through a physical random access channel (PRACH) defined by a base station in step S110. At this time, the preamble is one of the random access preambles designated by the base station. A plurality of terminals may perform the random access at the same time by using the same random access resources and random access preamble.

The base station transmits information on the detected preamble, timing advance information for adjusting the uplink synchronization of the terminal, temporary cell-radio network temporary identifier (TC-RNTI) information, and uplink resource allocation information used by the terminal for transmitting the message to the terminal in step S120.

The terminal receives a message transmitted by the base station based on the random access preamble and the location of the PRACH in which the random access preamble is transmitted. The terminal adjusts the uplink synchronization based on the information received from the base station and transmits the message through the allocated uplink resource in step S130. The uplink message of the terminal includes a unique identifier (e.g., an SAE-Temporary Mobile Subscriber Identity (S-TMSI) or an arbitrarily set value) of the terminal and information according to the state of the terminal.

The base station receives the uplink message of the terminal in step S140. When the plurality of terminals transmits the random access preamble, the base station receives a plurality of uplink messages from the plurality of terminals on the allocated uplink resources. At this time, the base station selects one of successfully received uplink messages and transmits a contention resolution message. If the contention resolution message received from the base station is not related to the uplink message transmitted by the base station, the terminal again performs random access from step S101.

The terminal randomly selects the random access preamble and initiates the random access by transmitting the random access preamble through one of the PRACH resources capable of transmitting a preamble. In this case, when a plurality of terminals select the same random access preamble at the same time and transmit the random access preamble through the same PRACH resource, a terminal that cannot access to the base station may occur due to the collision between random access preambles or between the uplink messages after uplink resource allocation.

In an environment where a plurality of terminals connects to a network, the probability of collision between signals transmitted from a plurality of terminals increases. A terminal that has failed the random access due to the collision again initiates the random access and competes with other terminals performing random access to access the network through the random access. That is, terminals that fail to complete the random access due to the collision continue to be accumulated, and thus the collision probability between signals (including preambles or uplink messages) may also be increased. In this case, the success probability of the random access is reduced due to the congestion.

The impact of the collision may be more significant in low-cost terminals and mission critical situations. For the low-cost terminals, the battery consumption problem may be important due to repeated transmission of the preamble. In the mission critical situations, a terminal may not be able to successfully transmit data within a predetermined time due to a preamble collision. When the random access preamble is transmitted with many repetitions in order to support a terminal having poor coverage, the problem of battery consumption and delay may be further deteriorated.

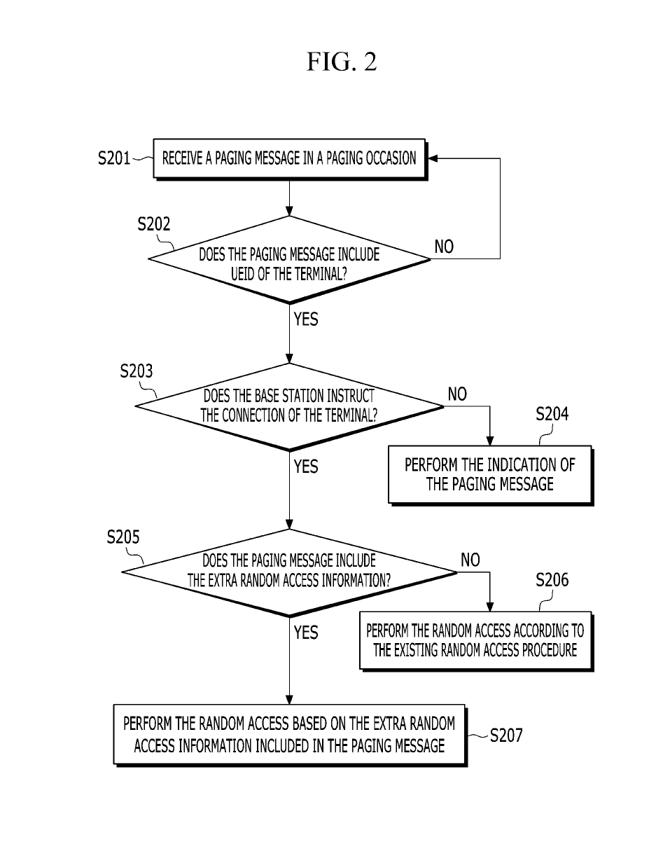

FIG. 2 is a flowchart illustrating a method for selecting a random access procedure by a terminal according to an exemplary embodiment.

A base station according to an exemplary embodiment transmits information for random access to each terminal or a terminal group through a paging message. In this description, a random access information which the base station exceptionally and additionally provides to the terminal for random access is referred to as ‘additional random access information’. When each terminal or the terminal group receives a paging message including information for random access from a base station, each terminal may perform the random access by reflecting information for random access included in a paging message.

Referring to FIG. 2, a terminal receiving a paging message in a paging occasion in step S201 checks whether UEID (user equipment identification) of the terminal itself is included in the paging message in step S202. The step S202 is to check whether the paging message is for the terminal itself. If the UEID is not included in the paging message, the terminal receives another paging message.

Then, the terminal determines whether the base station instructs the terminal to access based on the paging message in step S203. If the base station does not instruct the terminal to access, the terminal performs the instructions included in the paging message in step S204. If the base station has instructed the terminal to access, the terminal determines whether the paging message includes the additional random access information in step S205.

If the paging message does not include the additional random access information, the terminal performs the random access according to the existing random access procedure in step S206. If the additional random access information is included in the paging message, the terminal performs the random access based on the additional random access information in step S207.

According to the exemplary embodiment, the additional random access information may include an index indicating a specific random access resource or an index indicating a specific random access resource group.

According to the exemplary embodiment, the index indicating the specific random access resource may be included in the paging message. In this case, the index for the specific random access resource may be used to indicate a random access resource on time-frequency, or may be used to indicate a random access preamble on a code. Alternatively, it may refer to the random access resource on time-frequency, or may refer to the random access preamble on the code. The use of the index for the specific random access resource may differ depending on the random access method supported by the base station and the terminal. The index for the specific random access resource may indicate the entire random access resource available to all terminals performing the random access. Alternatively, it may indicate some random access resource to be used for a predetermined purpose among the entire random access resources.

According to the exemplary embodiment, a base station may allocate 64 preambles for the random access, and 16 preambles among the 64 preambles may be designated for a predetermined purpose. From now on, we use the number of preambles as 16 and 64 as explicit examples for explanation. Note that the exact number can vary depending on the random access setting. In this case, the paging message to be transmitted to the terminal A by the base station includes a 4-bit index indicating the 16 preambles. The terminal A receives the paging message from the base station and selects a preamble based on the random access preamble information included in the paging message. Then the terminal A performs the random access by using the selected preamble.

According to another exemplary embodiment, an index indicating a specific random access resource group may be included in the paging message. The specific random access resource group may represent a resource group on time-frequency, or may represent a group of random access preambles on the code. Alternatively, the specific random access resource group may refer to the resource group on time-frequency or the random access preamble group on the code. The use of the index of the random access resource group may differ depending on the random access method supported by the base station and the mobile station. The specific random access resource group consists of a group of at least one random access resource and is used for a classification for an initial access and a retransmission, a classification according to a service requirement, or a classification according to a service type. The index for the specific random access resource group may have the same meaning as an index indicating a specific situation. When the index for the specific random access resource group has a meaning of the index indicating the specific situation, the terminal recognizes the specific situation through the index, and may perform the random access through a predetermined procedure or a predetermined random access resource. In this case, the predetermined procedure or the predetermined random access resource may be pre-configured in the terminal or may be set in the terminal through broadcasting information such as system information transmitted by the base station.

According to yet another exemplary embodiment, the base station may allocate 64 preambles for random access, and some preambles among the 64 preambles may be included in four preamble groups respectively indicating four different services. In this case, the paging message to be transmitted from the base station to the terminal A includes a 2-bit index indicating the four preamble groups. The terminal A receives the paging message from the base station and selects a preamble based on the random access preamble group information included in the paging message. Then, the terminal A performs the random access by using the selected preamble.

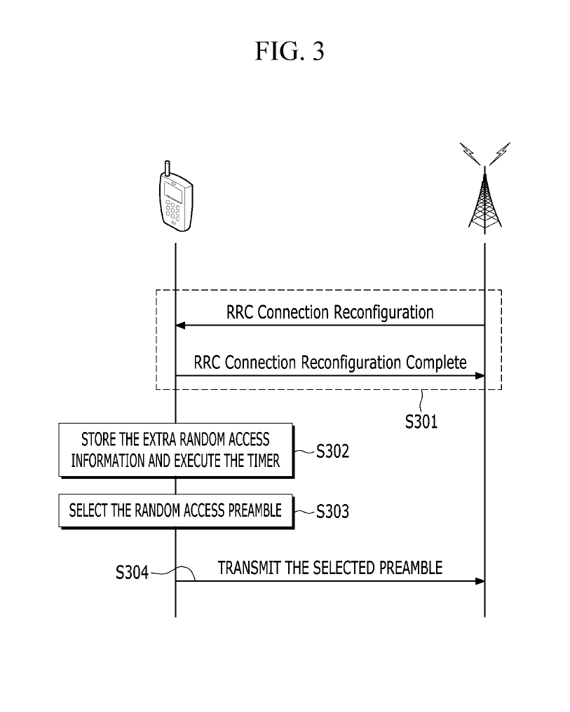

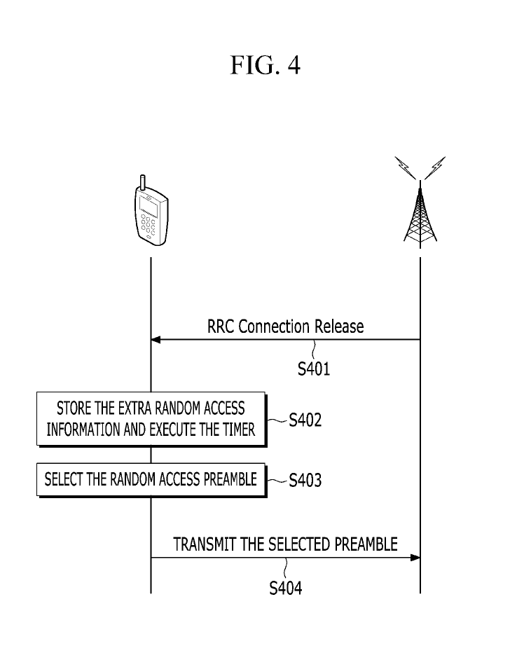

FIG. 3 is a flowchart illustrating a method for performing random access by using an RRC connection reconfiguration message according to an exemplary embodiment, and FIG. 4 is a flowchart illustrating a method for performing random access by using an RRC connection release message according to an exemplary embodiment.

A base station according to an exemplary embodiment provides additional random access information used by a terminal performing random access when there are services requiring a specific purpose (for example, a terminal reporting an emergency situation, or a low latency at a relatively short frequency) or service requirements such as a quality of service (QoS) of a connected terminal, and so on.

The additional random access information may be provided to the terminal when the base station transmits information to control the terminal. For example, the information for controlling the terminal may include a radio resource control (RRC) connection reconfiguration message or an RRC connection release message. If the additional random access information is provided to the terminal, the terminal may perform the random access by using the additional random access information received from the base station.

Referring to FIG. 3, the terminal receives the additional random access information through the RRC connection reconfiguration message and transmits an RRC connection reconfiguration complete message to the base station in step S301. Thereafter, the terminal stores the additional random access information and executes the timer related to the additional random access information in step S302. When providing the additional random access information to the terminal, the base station may provide an exception random access timer for indicating the valid time duration of the additional random access information. That is, the terminal may recognize whether the additional random access information is valid through the additional random access information timer when the terminal uses the additional random access information.

The terminal performs the random access to connect again to the base station after the RRC connection is terminated. At this time, if the additional random access information timer has not been terminated, the terminal selects a random access resource (i.e., a random access preamble) based on the additional random access information in step S303. Then, the terminal transmits the selected random access preamble to the base station to perform the random access in step S304.

Referring to FIG. 4, the terminal receives the additional random access information through an RRC connection release message in step S401. Then, the steps in which the terminal stores the additional random access information, executes the exception random access information timer (S402), selects the random access preamble based on the additional random access information (S403), and performs the random access by using the selected random access preamble (S404) are the same as steps S302 to S304 of FIG. 3.

When the timer related to the additional random access information expires, the terminal deletes the additional random access information, and the base station also deletes the additional random access information provided to the terminal.

The terminal checks the base station to which the terminal belongs through a synchronization signal before performing the random access. If the base station confirmed through the synchronization signal is different from the base station providing the additional random access information, the terminal performs the random access according to the existing random access procedure. For example, if the physical cell ID of the base station identified through the synchronization signal is different from the physical cell ID of the base station providing the additional random access information, the terminal deletes the provided additional random access information and performs the random access according to the existing random access procedure.

According to an exemplary embodiment, the additional random access information may include an index indicating a specific random access resource. In this case, the index for the specific random access resource may be used to indicate a random access resource on time-frequency, or may be used to indicate a random access preamble on a code. Alternatively, it may refer to the random access resource on time-frequency, or may refer to the random access preamble on the code. The use of the index for the specific random access resource may differ depending on the random access method supported by the base station and the terminal. The index for the specific random access resource may indicate the entire random access resource available to all terminals performing the random access. Alternatively, it may indicate some random access resource to be used for a predetermined purpose among the entire random access resources.

According to the exemplary embodiment, a base station may allocate 64 preambles for the random access, and 16 preambles among the 64 preambles may be designated for a predetermined purpose. In this case, the base station may provide an index of an additional random access preamble to a terminal B through the RRC connection reconfiguration message or the RRC connection release message.

The terminal B stores the index of the additional random access preamble and executes a timer when releasing or reconfiguring the RRC connection to the base station. In this case, the timer may be a timer related to the valid time duration of the additional random access information or may be an internal timer of the terminal. When the terminal B has been disconnected with the base station performs a random access for reconnection to the base station, the terminal B selects one of the preambles indicated by the index of the additional random access preamble. Then, the terminal performs the random access by using the selected preamble.

According to another exemplary embodiment, the additional random access information may include an index indicating a specific random access resource group. The specific random access resource group may represent a resource group on time-frequency, or may represent a group of random access preambles on the code. Alternatively, the specific random access resource group may refer to the resource group on time-frequency or the random access preamble group on the code. The use of the index of the random access resource group may differ depending on the random access method supported by the base station and the mobile station. The specific random access resource group consists of a group of at least one random access resource, and is used for a classification for an initial access and a retransmission, a classification according to a service requirement, or a classification according to a service type. The index for the specific random access resource group may have the same meaning as an index indicating a specific situation. When the index for the specific random access resource group has a meaning of the index indicating the specific situation, the terminal recognizes the specific situation through the index, and may perform the random access through a predetermined procedure or a predetermined random access resource. In this case, the predetermined procedure or the predetermined random access resource may be pre-configured in the terminal, or may be set in the terminal through broadcasting information such as system information transmitted by the base station.

According to yet another exemplary embodiment, the base station may allocate 64 preambles for random access, and some preambles among the 64 preambles may be included in four preamble groups respectively indicating four different services. In this case, the base station may provide an index (e.g., 2-bit) indicating the four additional random access preamble groups to the terminal B through the RRC connection reconfiguration message or the RRC connection release message.

The terminal B stores the index of the additional random access preamble group and executes a timer when releasing or reconfiguring the RRC connection to the base station. In this case, the timer may be a timer related to the valid time duration of the additional random access information or may be an internal timer of the terminal. When the terminal B that has been disconnected with the base station performs a random access for reconnection to the base station, the terminal B selects one of the preambles indicated by the index of the additional random access preamble group. Then, the terminal performs the random access by using the selected preamble.

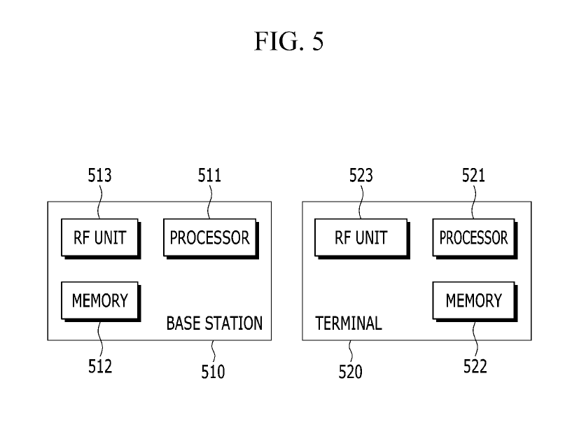

FIG. 5 is a block diagram illustrating a wireless communication system according to an exemplary embodiment of the present invention.

Referring to FIG. 5, a wireless communication system according to an exemplary embodiment includes a base station 510 and a terminal 520. The base station 510 includes a processor 511, a memory 512, and a radio frequency unit (RF unit) 513. The memory 512 may be connected to the processor 511 to store various pieces of information for driving the processor 511 or at least one program executed by the processor 511. The radio frequency unit 513 may be connected to the processor 511 to transmit/receive a wireless signal. The processor 511 may implement functions, processes, or methods proposed by the exemplary embodiment. In this case, in the wireless communication system according to the exemplary embodiment, a wireless interface protocol layer may be implemented by the processor 511. An operation of the base station 510 according to the exemplary embodiment may be implemented by the processor 511.

The terminal 520 includes a processor 521, a memory 522, and a radio frequency unit 523. The memory 522 may be connected to the processor 521 to store various pieces of information for driving the processor 521 or at least one program executed by the processor 521. The radio frequency unit 523 may be connected to the processor 521 to transmit/receive a wireless signal. The processor 521 may implement functions, processes, or methods proposed by the exemplary embodiment. In this case, in the wireless communication system according to the exemplary embodiment, a wireless interface protocol layer may be implemented by the processor 521. An operation of the terminal 520 according to the exemplary embodiment may be implemented by the processor 521.

According to the exemplary embodiment of the present invention, the memory may be positioned inside or outside the processor, and the memory may be connected to the processor through various already known means. The memory may be various types of volatile or non-volatile storage media. For example, the memory may include a read-only memory (ROM) or a random access memory (RAM).

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A method for performing random access by a terminal, comprising:
receiving additional random access information from a base station after connecting to the base station;
selecting a random access preamble based on the additional random access information; and
performing the random access by using the selected random access preamble.

2. The method of claim 1, wherein the additional random access information includes
an index indicating a specific random access resource or an index indicating a specific random access resource group.

3. The method of claim 1, wherein the receiving additional random access information comprises
receiving a paging message from the base station,
the method further comprising,
if the paging message includes the additional random access information, selecting the random access preamble based on the additional random access information, and if the paging message does not include the additional random access information, performing the random access according to the existing random access procedure.

4. The method of claim 1, wherein the receiving additional random access information comprises
receiving a radio resource control (RRC) connection reconfiguration message from the base station,
wherein the RRC connection reconfiguration message includes the additional random access information.

5. The method of claim 1, wherein the receiving additional random access information comprises
receiving a radio resource control (RRC) connection release message from the base station,
wherein the RRC connection release message includes the additional random access information.

6. The method of claim 1, further comprising
executing an additional random access timer for indicating a valid time duration of the additional random access information, and
the selecting a random access preamble based on the additional random access information comprises
selecting the random access preamble based on the additional random access information when the connecting to the base station is completed before the additional random access timer expires.

7. The method of claim 6, further comprising
deleting the additional random access information after the additional random access timer expires.

8. A terminal performing random access, comprising
a processor, a memory, and a radio frequency (RF) unit,
wherein the processor executes a program stored in the memory to:
receive additional random access information from a base station after connecting to the base station;
select a random access preamble based on the additional random access information; and
perform the random access by using the selected random access preamble.

9. The terminal of claim 8, wherein the additional random access information includes
an index indicating a specific random access resource or an index indicating a specific random access resource group.

10. The terminal of claim 8, wherein,
when receiving additional random access information, the processor
receives a paging message from the base station, and
the processor executes the program to further perform,
if the paging message includes the additional random access information, selecting the random access preamble based on the additional random access information, while if the paging message does not include the additional random access information, to perform the random access according to the existing random access procedure.

11. The terminal of claim 8, wherein,
when receiving additional random access information, the processor
receives a radio resource control (RRC) connection reconfiguration message from the base station,
wherein the RRC connection reconfiguration message includes the additional random access information.

12. The terminal of claim 8, wherein,
when receiving additional random access information, the processor
receives a radio resource control (RRC) connection release message from the base station,
wherein the RRC connection release message includes the additional random access information.

13. The terminal of claim 8,
wherein the processor executes the program to further
executes an additional random access timer for indicating a valid time duration of the additional random access information, and
when selecting a random access preamble based on the additional random access information, the processor
selects the random access preamble based on the additional random access information when the connecting to the base station is completed before the additional random access timer expires.

14. The terminal of claim 13,
wherein the processor executes the program to
delete the additional random access information after the additional random access timer expires.

15. A base station, comprising: a processor, a memory, and a radio frequency (RF) unit,
wherein the processor executes a program stored in the memory to:
transmit additional random access information to a terminal after the terminal is connected to the base station;
receive a random access preamble selected based on the additional random access information; and
transmit uplink resource allocation information to the terminal.

16. The base station of claim 15, wherein
the additional random access information includes
an index indicating a specific random access resource or an index indicating a specific random access resource group.

17. The base station of claim 15, wherein,
when transmitting additional random access information, the processor
transmits a radio resource control (RRC) connection reconfiguration message including the additional random access information to the terminal.

18. The base station of claim 15, wherein
when transmitting additional random access information, the processor
transmits a radio resource control (RRC) connection release message including the additional random access information to the terminal.

19. The base station of claim 15,
wherein the processor further executes the program to
delete the additional random access information after an additional random access timer for indicating a valid time duration of the additional random access information expires.
